(19) United States
(12) Patent Application Publication
(10) Pub. No.: US 2024/0239647 A1
(43) Pub. Date: Jul. 18, 2024

(54) VESSELS WITH INTEGRATED PUMP HAVING MULTIPLE OUTLETS AND RETURN LINES WITH AGITATION OR MIXING PROPERTIES

(71) Applicant: ALPHINITY USA, INC., Carson City, NV (US)

(72) Inventor: Michael C. Gagne, Carson City, NV (US)

(73) Assignee: ALPHINITY USA, INC., Carson City, NV (US)

(21) Appl. No.: 18/561,906

(22) PCT Filed: Jun. 2, 2022
(86) PCT No.: PCT/US2022/031966

§ 371 Date: Nov. 17, 2023

Related U.S. Application Data
(60) Provisional application No. 63/197,250, filed on Jun. 4, 2021.

(51) Int. Cl. B67D 7/62; B01L 3/00

(52) U.S. Cl. CPC B67D 7/62; B01L 3/502; B01L 2200/0642; B01L 2300/0851; B01L 2300/123; B01L 2400/0487

(57) ABSTRACT

A bioprocess or pharmaceutical vessel which may include a flexible bag or substantially rigid container defines an interior volume and having a bottom surface, the bottom surface being open or containing an aperture therein for the passage of fluid. A pump is secured to the bottom surface of the vessel. The pump has an inlet that is in fluidic communication with the interior of the vessel and a plurality of outlets, whereby fluid passes from the interior volume of the vessel and into the inlet of the pump and out the plurality of outlets. The vessel may also include one or more return lines that return fluid to the interior volume of the vessel. When fluid is pumped through the return lines, the return lines undulate, flail about, or otherwise move to impart agitation and/or mixing of the fluid contained in the vessel.

### RELATED APPLICATION

This application claims priority to U.S. Provisional Patent Application No. 63/197,250 filed on Jun. 4, 2021, which is hereby incorporated by reference in its entirety. Priority is claimed pursuant to 35 U.S.C. § 119 and any other applicable statute.

### TECHNICAL FIELD

The field of the invention generally relates to fluid-based systems and processes used in the manufacture, production, or capture of products. More specifically, the invention pertains to vessels such as bioprocess or pharmaceutical fluid containers, media and buffer bags, reactors, and fermentation units used in connection with pharmaceutical, biological, gene therapy applications or other hygienic process industries.

### BACKGROUND

Many commercial products are produced using chemical as well as biological processes. Pharmaceuticals, for example, are produced in commercial quantities using scaled-up reactors and other equipment. So-called biologics are drugs or other compounds that are produced or isolated from living entities such as cells or tissue. Biologics can be composed of proteins, nucleic acids, biomolecules, or complex combinations of these substances. They may even include living entities such as cells. For example, in order to produce biologics on a commercial scale, sophisticated and expensive equipment is needed. In both pharmaceutical and biologics, for example, various processes need to occur before the final product is obtained. In the case of biologics, mammalian cells may be grown in a container such as a growth chamber, reactor, bag or the like and nutrients may need to be carefully modulated into the unit holding the cells.

Importantly, biologic products produced by living cells or other organisms may need to be filtered, extracted, concentrated, and ultimately collected from the growth container. Waste products produced by cells typically have to be removed on a controlled basis from the growth container. Typically, desired biologic products produced by cells and/or waste products are pumped out of the container where growth occurs using a separate pumping device that is located downstream with respect container containing the cells. This pumped fluid that is removed from the growth chamber is typically subject to downstream processing such as separation or filtration. Filtration is performed to separate or concentrate a fluid solution and in biotechnology and pharmaceutical manufacturing processes is critical for the successful and efficient production of drugs and other desirable products.

Various separation and filtration devices can be used to process the fluid pumped of the container unit where cell growth takes place. One common technique that is used to filter or separate components from the fluid is tangential flow filtration (TFF) where a filter or membrane is used to filter species contained in the fluid based on, for example, physical size. The flow is tangential to the membrane to reduce the accumulation of waste products, dead cells, and biofilm that tends to clog the filter membrane. Another separation technique utilizes acoustic wave separation (AWS) technology for cell harvesting and clarification. In contrast to methods like TFF. AWS does not achieve separation of cells using a physical barrier or filter, but with high-frequency resonant ultrasonic waves.

More recently, perfusion methods for growing cells have been developed. In the perfusion method, culture medium which is depleted of nutrients and contains waste products generated by the cells, is continuously removed from the cell culture and replaced with fresh culture media. The perfusion method enables one to achieve high concentrations of cells and permits the production process to run continuously unlike batch process. In perfusion methods, there still is a need to separate and/or filter the generated drugs and waste products from the continuously circulate cells. Perfusion methods, however, are known to have lower reliability because the cells are frequently damaged during the separation and/or filtration process which separates the medium from the cells. Various solutions have been proposed to address the known disadvantages of perfusion growth methods. U.S. Pat. No. 6,544,424 discloses a fluid filtration system that attempts to address the low reliability of perfusion methods. The system described in the '424 patent utilizes a hollow fiber module that is coupled at one end to a separate diaphragm pump. The pump is used to generate alternating flow across follow fibers or a filter screen.

A problem with solutions such as that disclosed in the '424 patent is that the separate pump located downstream of the vessel containing cells is connected to the vessel through various conduits and the hollow fiber module. When incorporating pumps into fluid pathways, there is a need to design such systems to avoid problems caused by cavitation, vacuum or pulsed flow condition. Cavitation and non-steady flow conditions tend to lyse the delicate mammalian cells that are used in these manufacturing processes. Pumping and vessel systems must therefore be designed to avoid these problems. Technically, this means that the pump and system must be designed such that the Net Positive Suction Head Available (NPSH_{A}) exceeds the Net Positive Suction Head Available Required (NPSH_{R}) to ensure the pump will operate without cavitation or other adverse flow conditions. Unfortunately, when pumps are placed downstream from the container like that disclosed in the '424 patent, this inevitably tends to produce cavitation, vacuum, and problematic flow conditions that tend to kill or disrupt cells.

In addition, in many cell growth systems like those discussed above, a flexible segment of tubing connects the cell-containing vessel to the pump and any associated filtration/separation devices. Unfortunately, this configuration suffers from a problem in that due to upstream “negative” pumping pressure, the flexible tubing may collapse in on itself. This collapse of the tubing causes the inner surfaces of the tubing to contact one another and thereby prevents the further flow of fluid in the tubing. Even if the tubing does not fully close off, the presence of the tubing may lead to cavitation and other deleterious pulsatile flow conditions. For example, the irregular and often tortious paths of the tubing or conduit disrupts the fragile state of cells. These flow conditions may cause damage to the pump as well as disrupting and interfering with the cells contained in the fluid. Attempts have been made to address this in pump design. For example, the Quantum peristaltic pump made by Watson Marlow attempts to reduce shear using a single-use cartridge but this pump still is connected via a feed line that is located some distance from the reservoir. This causes pulsation at low flow rates and does not solve the main problem of getting fluid into the pump efficiently.

International Patent Application No. PCT/US2018/015777, which is incorporated herein by reference, describes a fluid vessel for containing biological/pharmaceutical fluids that overcomes the above limitations by incorporating a pump that is either directly or indirectly incorporated into the fluid vessel. Additional improvements in the designs of such fluid vessels having an integrated pump are desired.

### SUMMARY

In one embodiment, a fluid vessel for containing biological or pharmaceutical fluids includes a pump that is either directly or indirectly incorporated into the fluid vessel. In one embodiment, a hole or aperture is located in a bottom surface of the vessel that allows passage of fluid out of the vessel. The hole or aperture, in some embodiments, may actually encompass some, most, or all of the bottom surface of the vessel, leaving a perimeter or circumferential surface to which the pump is adhered to. The pump is incorporated into or attached to the vessel at the location of the aperture or opening at the bottom of the vessel. In some embodiments, the pump is secured to the vessel through an intermediate component such as a port or flange that passes through the aperture and is secured to the vessel in a fluid tight arrangement (or manufactured in conjunction with the vessel). The pump is then secured to the flange. In another embodiment, the pump is directly secured to the vessel. For example, the pump head of the pump may be integrally formed with the vessel during the manufacturing process. Alternatively, in still another embodiment, the pump head may be secured to the vessel using one or more fasteners. The pump head may also be directly bonded to the vessel using thermal bonding, an adhesive, glue, weld, or the like.

As explained herein, the pump or pump head may incorporate a plurality of outlets. For example, the pump or pump head which forms part of the pump may have 2, 3, 4, 5, 6, 7, 8, 9, 10, or more separate outlets. The outlets may be designed to accommodate the same or different flows from each outlet. The outlets may be positioned about the periphery or sides of the pump or pump head in symmetrical or asymmetrical manner. The outlets of the pump may terminate in a variety of ends or connectors used in biopharmaceutical processes. These include hygienic connectors, barb locks, hose barbs, flanges, TC connectors, disposable aseptic connectors (DAC), and the like. The outlets may optionally include or incorporate a valve directly or indirectly in one or more of the outlets. Tubing or other conduit may also interface directly with the outlets of the pump (e.g., by welding to the outlets or the like). In still another embodiment, the outlets of the pump may simply be an aperture or opening through which fluid passes. This aperture or opening may be threaded internally so that the outlets can accommodate a threaded connecting component or insert that interfaces with the threaded outlets of the pump.

The outlets may lead to separate fluid lines (e.g., tubing or conduit) that are returned to the vessel. In other embodiments, these fluid lines are directed to different processes and unit operations prior to returning to the fluid vessel. As one example, the fluid line connected to the outlet may also operate as a return line that returns fluid directly the fluid vessel. The fluid line from other outlets may perform one or more active operations. For example, the fluid line may lead to a filter, gas sparger, waste remover, sensing unit (e.g., pH and conductivity), media addition unit, or separation unit prior to being returned to the fluid vessel. The fluid lines may include rigid pipe or conduit in one embodiment. In another embodiment, the fluid lines may also include a flexible tubing or conduit (e.g., silicone tubing). In some embodiments, for example, where fluid pressures are high, the flexible conduit or tubing is encapsulated using one or more external two-piece jackets that surround the flexible tubing and resist the high fluid pressures that exist within the flexible tubing. These jackets may be connected to other components (e.g., valves, process units, and the like) or to each other in an end-to-end arrangement until the fluid line returns to the fluid vessel.

The fluid lines that are connected to the plurality of outlets, in some embodiments, eventually return to the fluid vessel or are connected to other fluid lines that return to the fluid vessel. These “return lines” enter the fluid vessel from the top or side and have a length that extends some distance into the interior of the fluid vessel. In one embodiment, the different return lines may extend different distances into the interior of the fluid vessel. For example, one return line may have a length that places an end close to the bottom of the fluid vessel. Conversely, another return line may have a length that places an end close to the top of the fluid vessel. Other return lines may have lengths that are the same or different lengths (e.g., in between). In still other embodiments, the fluid lines that are connected to the plurality of outlets do not return to the vessel. That is to say, the outlet lines may be connected to other downstream systems or processes. For example, for a buffer preparation or inline dilution application, one or more of the outlets may lead to a downstream vessel or the like where fluid and/or reagents may be added and then pumped out in a similar manner.

In one preferred embodiment, the return lines inside the vessel are formed from flexible tubing so that when fluid is actually pumped through the return lines and into the interior of the fluid vessel the return lines move, snake, or oscillate back and forth to provide agitation or mixing of the liquid contained in the fluid vessel. The flexible tubing may be the same or different tubing used outside the vessel environment. The movement of the return lines resembles the snaking movement that a water hose makes when left on an unattended. This random movement of the return line aids in agitating and mixing the fluid contained in the fluid vessel. In some embodiments, the return lines may include one or more end features that aid in agitating and/or mixing the fluid contained. For example, the return lines may include fins, protuberances, branches, or other surface features. The return lines may also include holes or apertures formed in the ends which may further enable snaking back-and-forth motion within the liquid contained in the fluid vessel.

In one embodiment, the fluid vessel is a substantially rigid container. For example, the vessel may take the form of a tub, vat, barrel, bottle, tank (e.g., buffer tank), reactor, flask, or other container suitable for holding liquids. The fluid vessel may be incorporated into processes, in some embodiments, where the vessel is used as a bioreactor or fermenter. The fluid vessel may be made of any number of materials including metals, polymers, glass, and the like. In one preferred embodiment, the vessel is formed from a polymer or resin material and is made as a single-use device. Likewise, one or more portions of the pump (e.g., pump head) that is directly or indirectly secured to the vessel may also be made from a polymer or resin material which facilitates integration or bonding of the pump to the vessel. In some embodiments, both the pump and vessel are made from same material. In other embodiments, the pump and vessel are made from different materials.

In another embodiment, the fluid vessel is flexible container such as a bag. The bag is typically made from polymer or resin material(s) and may have any number of shapes and sizes. The flexible bag may be formed from one or multiple layers. The bag includes a pump that is directly or indirectly secured to a bottom surface of the bag. The bag and attached or integrated pump may be carried in a trolley, dolly, cradle, cart, holder, or other support container to hold the bag and pump in the proper orientation. In some embodiments, both the pump and bag are made from the same material. In other embodiments, the pump and bag are made from different materials.

In one embodiment, regardless of whether the vessel is flexible or substantially rigid, the pump includes a separate motor that is used to power and operate the pump. For example, one preferred embodiment of the pump is a diaphragm pump because of the gentle nature of the flows produced during operation. A diaphragm pump or membrane pump operates as positive displacement pump that uses moving membrane in combination with valves to pump fluid. In one embodiment, the drive shaft of the motor may be used to drive a nutating disk or wobble plate to actuate the diaphragm membrane to drive fluid through the pump. Alternatively, servo motors or electronic/magnetic actuators may be used to sequentially actuate the diaphragm membrane to achieve a similar pumping action. The pump includes an inlet port that receives the incoming fluid that passes through the aperture in the vessel or the open vessel bottom and outlet ports through which the pumped fluid passes.

In one embodiment of the invention the vessel itself is made to be single use or disposable. In addition, one or more components of the pump may be made disposable. For example, the pump head which in some embodiments is integrally formed with the vessel may be disposable or contain disposable components. In other embodiments where the pump head is secured to the vessel, the pump head may also be formed from one or more components that are single use components. Alternatively, the vessel, pump, and any interface components between the two like a port or flange may be sterilizable for reuse. The motor or other drive mechanism that is used to power and operate the pump is typically reusable.

In one embodiment, a vessel that is used, for example, bioprocess or pharmaceutical operations includes an integrated or connected pump. The vessel includes a flexible bag or a substantially rigid container defining an interior volume and having a bottom surface, the bottom surface containing an aperture therein for the passage of fluid. A pump is secured to the bottom surface of the vessel, the pump having an inlet in fluid communication with the interior volume via the aperture and a plurality of outlets, wherein the pump pumps fluid from the interior volume of the vessel into the inlet of the pump and out the plurality of outlets: and one or more conduits or tubing comprising return lines that are connected at one end to the plurality of outlets and having flexible free ends extending into the interior volume of the vessel.

In another embodiment, a method of pumping fluid from a vessel that is formed from a flexible bag or a substantially rigid container is disclosed. The vessel defines an interior volume and has a bottom surface, the bottom surface containing an aperture therein for the passage of fluid and wherein a pump is secured to the bottom surface of the vessel having an inlet in fluid communication with the interior volume via the aperture and a plurality of outlets coupled to respective conduits or tubing comprising return lines that are connected at one end to the plurality of outlets and having flexible free ends extending into the interior volume of the vessel. The method includes pumping a fluid contained in the vessel out the plurality of outlets of the pump and back into the vessel via the return lines.

The vessels described herein may include an optional that is secured either to the vessel itself or to the pump. The powder barrier at least partially covers a portion of the inlet to the pump. The powder barrier may be used to prevent solids and other materials that are fed into the vessel from directly entering the inlet of the port prior to properly mixing with the fluid. The powder barrier may also be omitted entirely.

### BRIEF DESCRIPTION OF THE DRAWINGS

FIG. 1 schematically illustrates one embodiment of a vessel having an integrated pump with multiple outlets. Also illustrated are the flexible return lines that have agitation/mixing functionality within the vessel.

FIG. 2 schematically illustrates another embodiment of a vessel having an integrated pump with multiple outlets. In this embodiment, the flexible return lines located outside the vessel are encapsulated in two-piece jackets. The flexible return line segments are located inside the vessel. Also illustrated interposed in the return lines are various processing units.

FIG. 3 illustrates one embodiment of a two-piece jacket that is used to encapsulate a segment of flexible tubing or conduit.

FIG. 4A illustrates the end of the flexible return line (located inside the vessel) according to one embodiment.

FIG. 4B illustrates the end of the flexible return line (located inside the vessel) according to another embodiment.

FIG. 4C illustrates the end of the flexible return line (located inside the vessel) according to another embodiment.

FIG. 4D illustrates the end of the flexible return line (located inside the vessel) according to another embodiment.

FIG. 4E illustrates the end of the flexible return line (located inside the vessel) according to another embodiment.

FIG. 5 schematically illustrates one embodiment of a rigid vessel having an integrated pump with multiple outlets. Also illustrated are the return lines that have agitation/mixing functionality within the vessel. In this embodiment, the external return lines may be rigid conduits or tubing or flexible conduits or tubing that are encapsulated in two-piece jackets.

FIG. 6 illustrates a vessel and connection port (which is used to attached or secure the pump) according to one embodiment.

FIG. 7A illustrates an exploded assembly view of a pump that is secured to a vessel according to one embodiment. The pump has a plurality of outlets.

FIG. 7B illustrates a side view of a pump that is secured to a vessel according to one embodiment. The pump has a plurality of outlets.

FIG. 8 schematically illustrates a vessel having a pump secured thereto with a plurality of outlets. The outlets are coupled to outlet lines. These outlet lines may be directed to other processes/systems and they may also be coupled to return lines the return fluid to the vessel.

FIG. 9 illustrates one embodiment of a vessel having a plurality of pumps with each pump having a plurality of outlets.

FIG. 10 illustrates a pump head according to one embodiment. An optional powder barrier is illustrated.

FIG. 11 illustrates one embodiment illustrating the use of the multi-outlet pump. Here, one of the outlets of a first pump coupled to a first vessel is pumped via conduit or tubing to a second vessel that is connected to a second pump.

### DETAILED DESCRIPTION OF THE ILLUSTRATED EMBODIMENTS

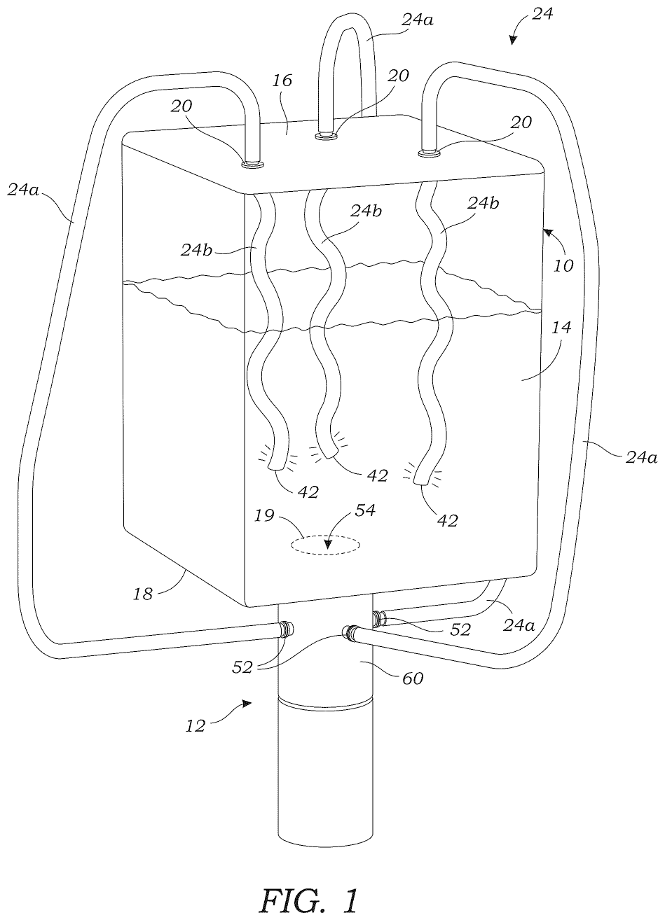

FIG. 1 illustrates one embodiment of a vessel 10 which may be a flexible bag or substantially rigid container that is integrated with or is secured to a pump 12. The vessel 10 defines an interior volume that is used to hold fluids therein. The interior of the vessel 10 defines a sterile or aseptic environment in which fluids, reagents, cells, or products are contained. The vessel 10 includes a number of side surfaces 14 as well as a top surface 16 and a bottom surface 18. The vessel 10 may have any number of shapes and sizes (e.g., one hundred liters or less to thousands of liters). While the illustrated vessel 10 has discrete surfaces (e.g., top, sides, bottom surface) in some embodiments there need not be such discrete demarcations. The vessel 10 includes top surface 16 that, in some embodiments, may include one or more ports 20 that define access passageways to the interior of the vessel 10. The ports 20 have any number of different sizes and configurations. While the ports 20 are illustrated being located in the top surface 16 the ports 20 may also be located on any surface of the vessel 10. For example, a port 20 may be located on the sides 14 of the vessel 10 or on the bottom surface 18 of the vessel 10. The ports 20 may provide access for the addition/return of materials including solids, liquids, and gases. The port(s) 20 may also be used to sample fluid contained in the vessel 10. The ports 20 may also provide access for one or more probes or sensors that are used to monitor conditions within the interior of the vessel 10. The ports 20 may also be used as vents. The ports 20, in some embodiments, may terminate in a variety of ends or connectors used in biopharmaceutical processes. These include hygienic connectors, hose barbs, flanges, TC connectors, disposable aseptic connectors (DAC), and the like.

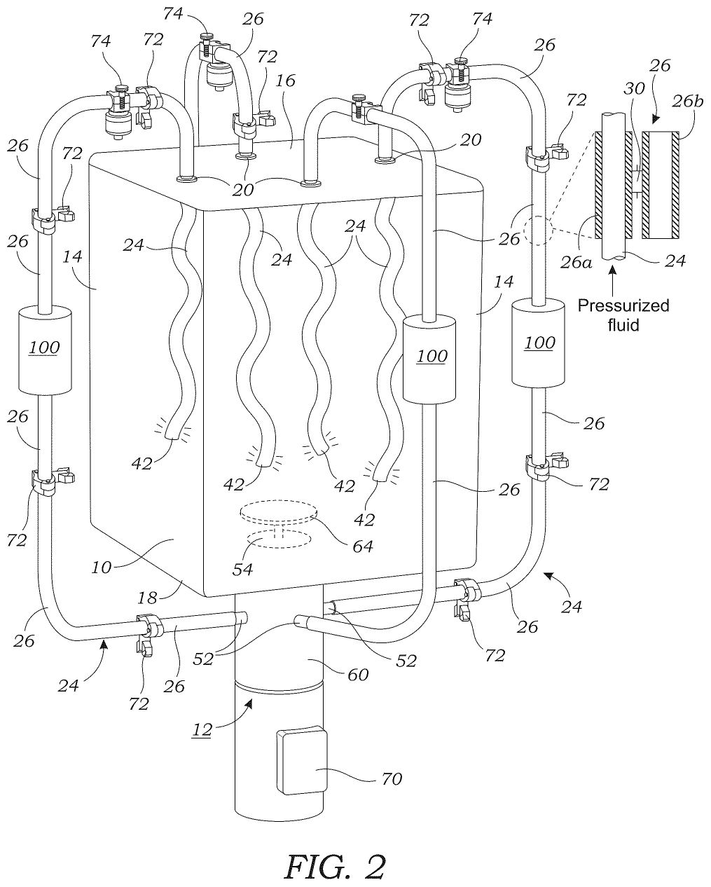

In one preferred embodiment, one or more of the ports 20 may also provide access for return lines 24 that return fluid to the vessel 10. The return lines 24 in one embodiment are at least partially formed from a flexible material such that the return lines 24 when inside the vessel 10 are able to bend and twist in response to fluid flow as explained herein in more detail. The flexible tubing or conduit that makes up the return lines 24 may be formed using an unreinforced polymer conduit or tube in some embodiments. For example, the flexible tubing or conduit 24 may be formed from platinum cured silicone however other materials may be used. These include, for example, a polymer such as thermoplastic elastomers (TPE), thermoplastic rubber (TPR), silicone, or other materials commonly used in pharmaceutical/biopharmaceutical application. The flexible tubing/conduit of the return lines 24 may have may have a variety of diameters and lengths. There may be any number of return lines 24 present in the vessel 10. This may include, for example, 2, 3, 4, 5, 6, 7, 8, 9, or 10 or more return lines 24. In some embodiments, the number of return lines 24 equals the number of outlets 52 from the pump 12 (described below) although there may be more or fewer return lines than the number of outlets 52 in other embodiments. The return lines 24 may return directly to the vessel 10 in some embodiments. In other embodiments, the return lines 24 may contain sensors or processing units 100 (like illustrated in FIG. 2) interposed along the fluid flow path of the return lines 24.

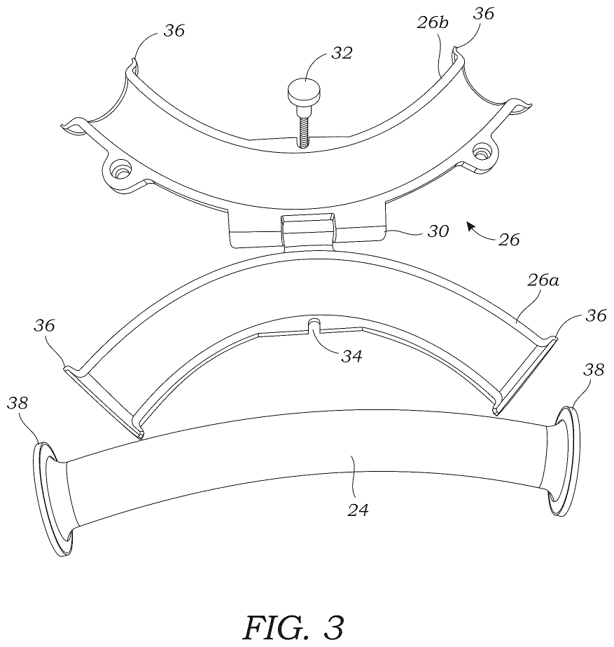

With reference to FIG. 2, in one preferred embodiment, the return lines 24 that are located outside or exterior to the vessel 10 are formed from a flexible tubing or conduit that is contained within a rigid exoskeleton or two-piece jacket 26. For example, as seen in FIG. 2, the flexible return lines 24 that are located external to the vessel 10 are contained in a rigid two-piece exoskeleton or jacket structure 26 that can be placed around the flexible tubing or conduit. The rigid two-piece exoskeleton/jackets 26 are, in some embodiments, connected to one another via a hinge 30 (see FIG. 3) that allow the two-piece jacket 26 to be closed around the flexible tubing or conduit of the return lines 24. The two-piece exoskeleton or jacket 26 may be opened so that replacement flexible tubing or conduit can be placed inside (e.g., the flexible tubing or conduit may be disposable). The rigid two-piece exoskeleton/jackets 26 advantageously enable very high pressures to be run through the return lines 24 without the flexible lines breaking or otherwise failing. It should be appreciated, however, that if operating pressures are low; there may be no need for the two-piece jackets 26.

FIG. 3 illustrates one embodiment of a two-piece exoskeleton or jacket 26 that may be used to enclose the flexible tubing or conduit of the return lines 24. The two-piece exoskeleton or jacket 26 includes a hinge 30 that connects the two halves 26a. 26b of the jacket 26. Each half 26a, 26b of the exoskeleton or jacket 26 defines a semi-annular inner surface that is dimensioned to snugly accommodate the flexible tubing or conduit of the return lines 24. The two-piece exoskeleton or jacket 26 may be closed using a threaded latch 32 that pivots into the illustrated notch 34. The two-piece exoskeleton or jacket 26 may optionally contained flanged ends 36 as illustrated in FIG. 3 (the flexible tubing or conduit of the return line 24 may also contain similarly shaped flanged ends 38). This enables adjacent two-piece exoskeletons or jackets 26 to be connected in an end-to-end fashion using clamps 72 (FIG. 2). The jackets 26 may also be coupled to other components such as valves, sensors, manifolds, unit operations using similar clamps 72.

In one preferred embodiment, when multiple return lines 24 are used, different return lines 24 have free ends 42 of the flexible tubing or conduit that terminate at different depths within the vessel 10 as seen in FIGS. 1 and 2. That is to say, the flexible tubing or conduit of the return lines 24 may have different lengths inside the vessel 10. Some return lines 24 may terminate closer to the bottom surface 18 while other return lines 24 may terminate closer to the top surface 16. Still other return lines 24 may terminate at intermediate levels within the vessel 10. Of course, not all return lines 24 may terminate at different levels within the vessel 10. In addition, the return lines 24 may all terminate at the same level.

The flexible tubing or conduit of the return lines 24 have “free” ends 42 that extend into the interior of the vessel 10 and have an open end through which fluid exits the return lines 24 into the vessel 10. The free ends 42 are preferably submerged in the fluid when present. The return lines 24 are configured to be freely hanging such that when liquid fluid flows through the return lines 24 and into the vessel 10 the return lines 24 undergo back-and-forth, undulating motion, or snake-like movement within liquid contained in the vessel 10 (illustrated in FIGS. 1, 2, 4A-4E, and 5). This movement of the return lines 24 and the attendant changing fluid direction of fluid that exits the return lines 24 into the vessel 10 aids in agitating and/or mixing of the fluid contained in the vessel 10. The motion of the flexible tubing or conduit of return lines 24 resembles that of an unattended water hose under pressure that uncontrollably moves in random directions in response the forces caused by the water exiting the hose. This motion is typically random (although not necessarily so): causing the return lines 24 to bend, rotate, and flail about within the vessel 10.

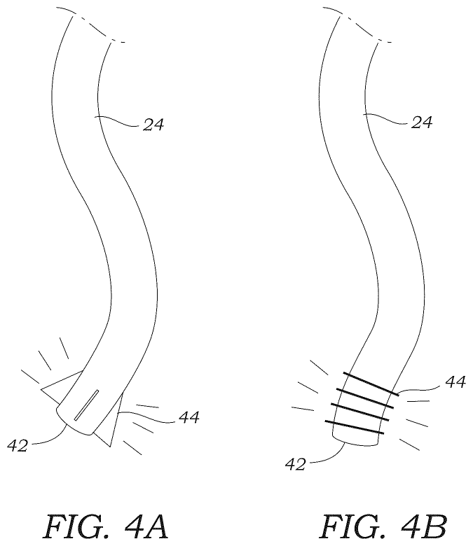

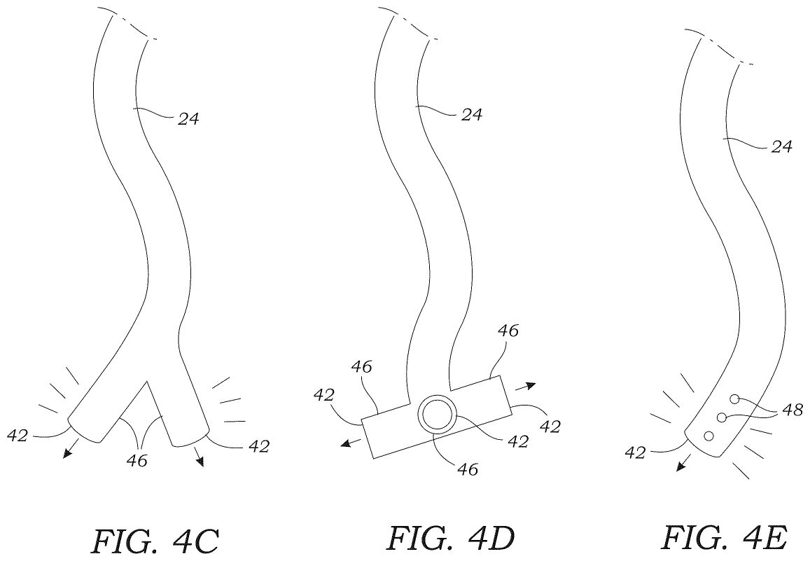

In one optional embodiment, as illustrated in FIGS. 4A and 4B, the return lines 24 may include end features 44 which may include fins, projections, or protuberances that are located on the exterior surface of the return lines 24 and aid in promoting mixing and/or agitation of the liquid in the vessel 10. In still another embodiment, as seen in FIGS. 4C and 4D, one or more of the return lines 24 may include branches 46 at the end such that flow is diverted in multiple directions when it exits. The branches 46 may further aid in mixing/agitating the fluid in the vessel 10. A single return line 24 may have multiple branches (e.g., 2, 3, 4, 5, or more branches). In another option, as seen in FIG. 4E, the return lines 24 may contain holes or apertures 48 along a side surface to aid in mixing and/or agitation. Combinations of the features of FIGS. 4A-4E are also contemplated. The lengths and configuration of the return lines 24 is such that the return lines 24 do not get tangled or tied up during operation. This may be accomplished by adjusting the entry points into the vessel 10, the lengths of the return lines 24, and even the flexibility or construction of the return lines 24.

In some embodiments, like that illustrated in FIG. 1, the return line 24 may be broken into multiple segments or sections. For example, a first segment 24a may connect at one end to a pump outlet 52 and at another end to a port 20 formed in the vessel 10. The port 20 may include, for example, a barbed end onto which the first segment 24a is coupled to. The port 20 may include a second segment 24b of the return line 24 that extends into the interior of the vessel 10. The second segment 24b is thus secured at one end to the port 20 and has the free end 42 located within the interior of the vessel 10. In this embodiment, the return line 24 is thus formed from a plurality of segments 24a. 24b. Of course, one could have additional segments that makeup the return line 24. The return line 24 may also be a single or unitary segment of conduit or tubing.

In one embodiment, the vessel 10 is flexible bag. The flexible bag, in one embodiment, is made from one or more polymers or resin materials. For example, medical-grade resins compliant with class VI standards may be used. Additional examples include polyethylene (PE), e.g., low density polyethylene (LDPE) or ultra-low-density polyethylene (ULDPE) or polypropylene (PP), ethylene vinyl acetate (EFA), polyethylene terephthalate (PET), polyvinyl acetate (PVA), polyvinyl chloride (PVC), ethylene-vinyl alcohol copolymer (EVOH), and the like are also contemplated. In some embodiments, the flexible bag may be formed from multiple layers. For example, the inner layer that contacts the fluid may be made from LDPE or PE and an outer layer made from EVOH. In some embodiments, a second layer of polyvinyl acetate (PVA) or flexible polyvinyl chloride (PVC) may be used as an intermediate layer. An outer layer of LDPE or PET may provide mechanical strength. Of course, the flexible bag may include fewer or more layers or even a single layer. It should be appreciated that the integrated pump 12 embodiments described herein may be used with any number of different construction types, materials, and layer(s) used for the flexible bag.

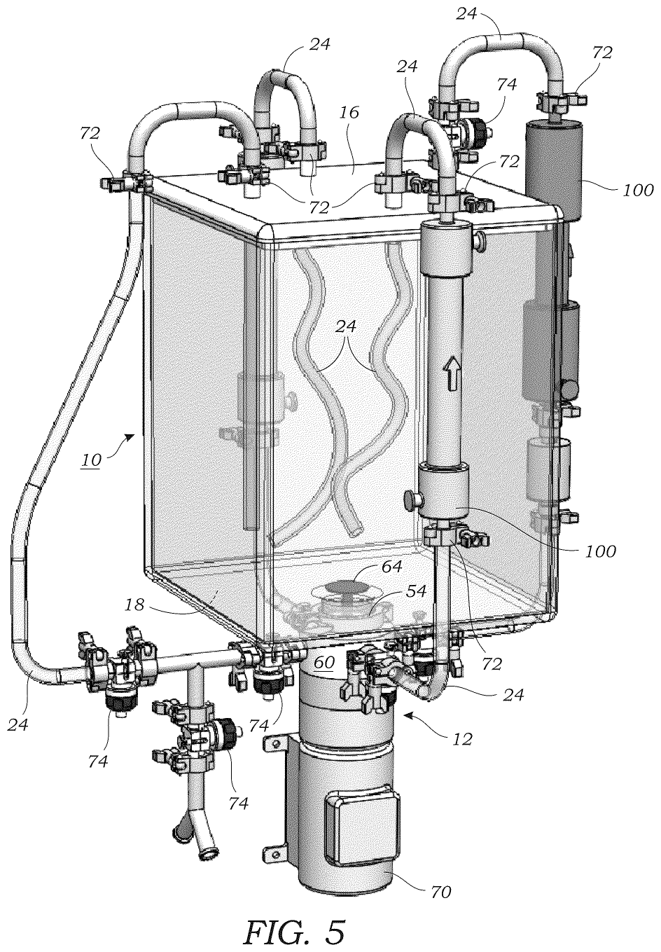

In another embodiment, such as that illustrated in FIG. 5, the vessel 10 is a substantial rigid container that may include a tub, vat, barrel, bottle, tank, flask, or the like. The substantially rigid container may be made, in one embodiment, in the form of a bioreactor or fermenter tank. The tank vessel 10 includes one or more side surfaces 14 and a bottom surface 18 where the pump 12 is located. The vessel 10 may be cylindrical in shape in some versions and may have a wide variety of volumes. It should be understood that the vessel 10 may have any number of geometric shapes and sizes. Typically, the height of the tank is at least 1.5 times the diameter of the tank but other sizes are contemplated. In one embodiment, the vessel 10 includes a liquid-containing tank and a lid or top surface 16 that contains ports 20 therein. These ports 20 may provide access to add or remove fluid containing the tank vessel 10. The ports 20 may also hold or contain sensors or probes that are used to monitor the conditions inside the tank vessel 10. The ports 20 may also provide access to mixers, gas introducers, agitators, gas bubblers, and the like. The ports 20, in some embodiments, may terminate in a variety of ends or connectors used in biopharmaceutical processes. These include hygienic connectors, hose barbs, flanges, TC connectors, disposable aseptic connectors (DAC), and the like. The ports 20 may be located in the lid or top surface 16 or they may also be incorporated into the tank itself (e.g., on the sidewalls) in some alternative embodiments. For example, one or more ports 20 may be located at a side surface 14 of the tank vessel 10. Like the flexible bag embodiment, the one or more ports 20 may also accommodate one or more return lines 24 as described herein (either as a unitary piece or segments of conduit or tubing). In one preferred embodiment, the ports 20 and return lines 24 enter the tank vessel 10 via the lid or top surface 16 that is located on the top of the tank or other vessel 10).

The tank vessel 10 and lid or top surface 16 may be made from a polymer, plastic material, or resin that mimics the performance of glass or stainless steel. The polymer material preferably complies with Class VI or ISO-10993 standards or higher levels (or whatever regulatory requirements may be required for the particular application) of biocompatibility and chemical resistance as needed, and is free of or contains low amounts of leachable and extractable material. Examples of polymers that can be used to form the substantially rigid container include polyethylene, polycarbonate, and as well as the materials noted above with respect to the flexible bag embodiment. Medical-grade resins compliant with class VI standards may also be used. Alternatively, the tank vessel 10 and/or lid or top surface 16 may be made from a metal such as stainless steel. The tank vessel 10 and/or lid or top surface 16 may also be made of glass. In some embodiments, the vessel 10 is designed as a single-use vessel 10 that is discarded after a batch or continuous run of products has completed. In other embodiments, the vessel 10 may be designed to be sterilized and reused.

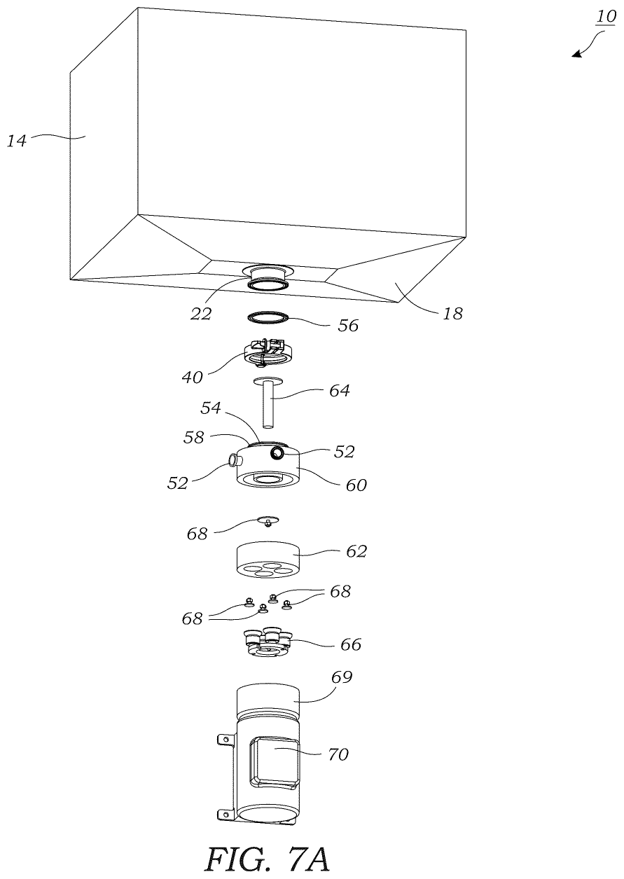

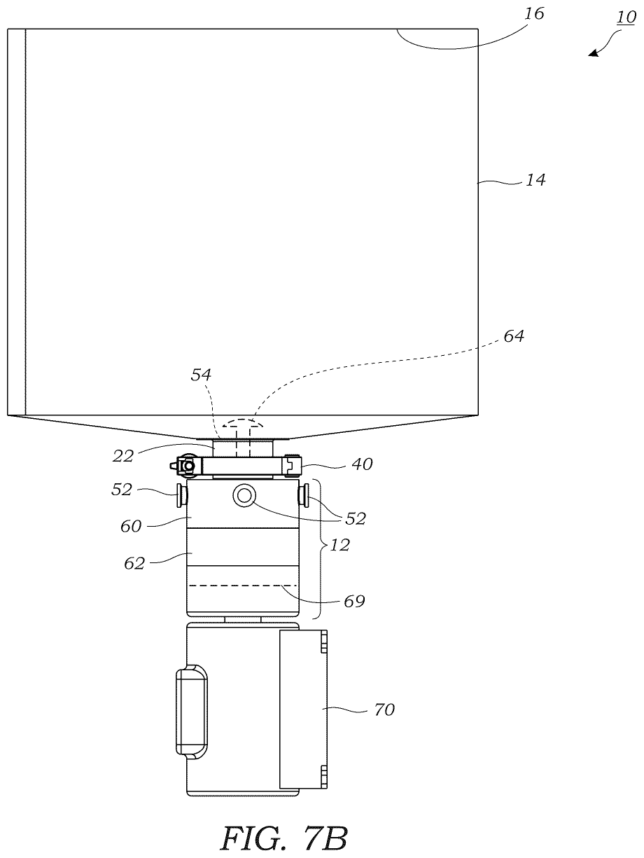

The pump 12 may be connected to the vessel 10 directly or indirectly as explained herein. A direct connection connects one or more surfaces of an inlet 54 of the pump 12 to the vessel 10. In contrast, an indirect connection connects the pump 12 (or inlet 54 of pump 12) to the vessel 10 using a connecting port 22 (as seen in FIG. 7A). The connecting port 22 is a rigid structure that is placed in or around an aperture 19 in the bottom surface 18 of the vessel 10 and is used an attachment point for the pump 12 (or pump head) to be secured or coupled to the vessel 10 and also permits the passage of fluid between the interior of the vessel 10 and the pump 12 (through the passage in the connecting port 22). The connecting port 22 may have one or more flanged surfaces. For example, the connecting port 22 may have a flanged surface that secures the connecting port 22 to the vessel 10. Another potential flanged surface includes a flange or other mount on which the pump 12 (or inlet 54 of the pump 12 (e.g., pump head)) is mounted or otherwise secured to. The connecting port 22 may be made from any number of materials including polymers materials such, for example, as polypropylene and polycarbonate, LDPE, high-density polyethylene (HDPE), or other medical-grade plastics or resins. The connecting port 22 may even be formed from metal in some embodiments. In some embodiments, the connecting port 22 is formed from the same material used for the vessel 10 although in other embodiments the connecting port 22 is formed from a material that is different from the vessel 10. International Patent Application No. PCT/US2018/015777, which is incorporated herein by reference, describes various ways in which a pump 12 may be secured to a vessel 10. All the variations and options described therein may also be used in conjunction with the current invention described herein. These include, securing the pump 12 to the vessel 10 via thermal bonding, an adhesive, glue, weld, or the like.

The connecting port 22 may be welded to the bottom surface 18 of the vessel 10 in some embodiments. Any known method of welding such components together including heat welding, resistive welding, spin welding, friction welding, laser welding, and the like. An adhesive may also be used to secure the connecting port 22 the bottom surface 18. Alternatively, the connecting port 22 may be integrally formed with the vessel 10 during the manufacturing process (e.g., in the molding or formation of the vessel 10 (e.g., flexible bag or rigid container or tank)). The connecting port 22 may also be made from a polymer or resin material than can bond the vessel 10 in response to, for example, applied heat.

On one embodiment, the connecting port 22 may include a flanged surface located outside of the vessel 10 that is a hygienic clamp that is commonly used in bioprocess and pharmaceutical systems. For example, tri-clamp (TC) type flanged surface is one type of hygienic clamp that is commonly used in bioprocess and pharmaceutical systems. In hygienic clamp connections two mating flanged surfaces are connected to one another at an interface that typically contains a ferrule gasket 56 (FIG. 7A) and a separate clamp 40 is used to secure the two components together. For example, the pump 12 may be secured to the connecting port 22 using a clamp such as clamp 40 (FIGS. 7A and 7B). While the flanged surface for the connecting port 22 is described it should be appreciated that other hygienic connectors such as male/female connectors, and the like (including proprietary connectors) may be used. Preferably, the connecting port 22 does not extend far out of the vessel 10 (i.e., it should be as short as possible; yet still accommodate a clamp 40 when one is used). Because the connector end of the connecting port 22 interfaces with a pump 12 (via flanged end 58), these connections may typically be large, e.g., 6″, 8″, 10″, or 12″ diameter opening depending on the size of the pump 12; although other sizes are contemplated. While the connected port 22 is illustrated it should be appreciated that in other embodiments, the connecting port 22 may be omitted entirely. For example, the pump 12 may be secured directly to the vessel 10.

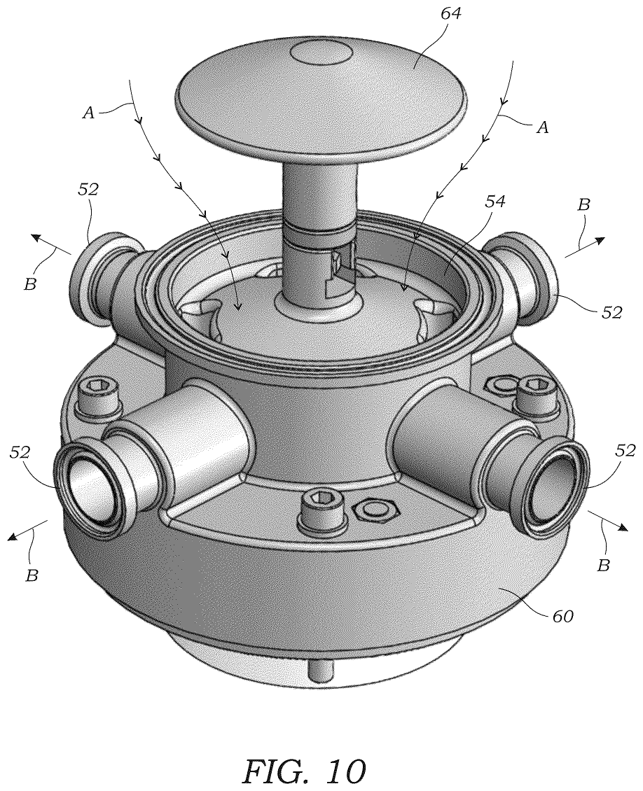

As best seen in FIGS. 7A and 7B, the pump 12 may include a pump head 60 and pump casing 62 that contains the operating components of the pump 12. The pump head 60 includes an inlet 54 the communicates with the interior of the vessel 10. Advantageously, the inlet 54 to the pump 12 is directly connected to the vessel directly or via the connecting port 22 (when used); there are no intervening tubes or conduits located between the pump 12 and the vessel 10. As explained herein, the pump head 60 has a plurality of outlets 52. This may include 2, 3, 4, 5, 6, 7, 8, 9, or 10 or more outlets 52. The outlets 52 may carry substantially the same flow rates in each respective outlet 52. Alternatively, the outlets 52 may carry different flow rates (e.g., the sizes of each outlet may be different). FIG. 10 illustrates a pump head 60 that contains (4) four outlets 52. Also illustrated in FIG. 10 is an optional powder barrier 64 that covers a portion of the inlet of the pump head 60. The powder barrier 64 minimizes the clumping of powders that are loaded into the vessel 10 from above.

The outlets 52 of the pump 12 may terminate in a variety of ends or connectors used in biopharmaceutical processes. These include hygienic connectors, barb locks, hose barbs, flanges, TC connectors, disposable aseptic connectors (DAC), and the like. The outlets 52 may include or incorporate a valve directly or indirectly in the outlet 52. Tubing or other conduit may also interface directly with the outlets 52 of the pump 12 (e.g., by welding to the outlet 52 or the like). In still another embodiment, the outlets 52 of the pump 12 may simply be an aperture or opening through which fluid passes. This aperture or opening may be threaded internally so that the outlets 52 can accommodate a threaded connecting component or insert that is screwed into the threaded outlet 52 of the pump 12. This may include a connector (not shown) that is screwed into the internally threaded outlet 52. The threaded connecting component or insert may include any number of ends or connectors used in biopharmaceutical/pharmaceutical processes such as those described herein.

The outlets 52 are generally illustrated in the FIGS. as being oriented generally orthogonal to vertical axis of the vessel 10. It should be appreciated that the outlets 52 may exit the pump 12 at an angle. For example, the outlets 52 may be angled downward to facilitate easier usage. An angle (relative to horizontal) of about 15° to 45° would be common, although other angles are contemplated.

The pump 12, in one embodiment, operates as a diaphragm pump. A diaphragm pump operates by the actuation of multiple diaphragms 66 (FIGS. 7A and 7B) which are sequentially actuated to create a gentle pumping action of fluid through the pump. The diaphragms 66 work in conjunction with check-valves 68 to ensure the flow of fluid through the pump 12 in one direction. In one embodiment, actuation of the diaphragms 66 is effectuated by a nutating or wobble plate 69 located below the diaphragms (FIGS. 7A and 7B) that rotates about central axis in response being driven by a drive shaft of a motor 70 to sequentially activate the diaphragms 66. The motor 70 is secured to the pump 12 and is coupled via a drive shaft (not shown) to the nutating disk or wobble plate 69 to actuate the multiple diaphragms 66 (in sequential fashion) and pump fluid through the pump 12 from the inlet 54 to the outlets 52. Any number of types of motors 70 may be used including direct current motors, alternating current motors, and the like. Additional details regarding the pumps 12 that may be used in connection with the vessels 10 disclosed herein may be found in International Patent Application No. PCT/US2021/015917 which is incorporated herein by reference.

While there are four (4) diaphragms 66 illustrated in FIG. 7A, it should be understood that other configurations of the pump 12 may contain fewer or more diaphragms 66. For example, additional diaphragms 66 may make for an even more smooth pumping action with reduced pulsatile flow effects. Likewise, while a motor 70 is illustrated as driving a nutating disk or wobble plate 69, an alternative construction of the pump 12 may utilize individual actuators (e.g., servo, electric, magnetic, or pneumatic) to sequentially actuate the diaphragms 66 to achieve the same pumping action without the need for a rotating disk or wobble plate 66. Thus, the motor 70 may be replaced with servo actuators, electric/magnetic actuators or the like that sequentially actuate the diaphragms 66 in a similar manner.

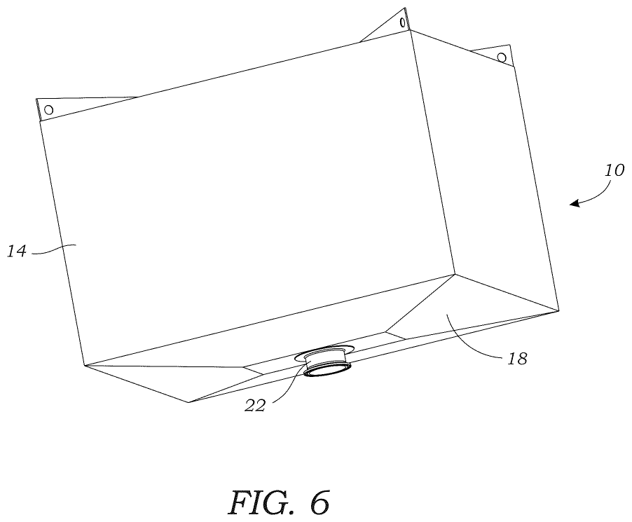

FIGS. 2, 5, 7A, 7B, and 10 illustrate an optional powder barrier 64 that is used to at least partially cover the aperture 19 in the vessel 10 according to one embodiment. The powder barrier 64 is used to ensure that materials such as powders or other solid media that may be added to the vessel 10 via a port 20 do not fall directly into the inlet 54 where the materials could interfere with the operation of the pump 12. The powder barrier 64 also aids in mixing the fluid. In particular, as seen in FIG. 6B, the powder barrier 64 includes a top curved surface in one embodiment that at least partially covers the cross-sectional area of the aperture 19 in the vessel 10. Fluid is able to enter the inlet of the pump 12 around the sides of the powder barrier 64. As seen in FIGS. 7A and 7B, the powder barrier 64 may be secured to the pump head of the pump 12 and projects centrally within the inlet 54 of the pump 12. The powder barrier 64 may be made from any compatible materials including polymers and resins such as those described herein as well as metal (e.g., stainless steel). Of course, it should be appreciated that the powder barrier 64 may be omitted entirely.

With reference back to FIGS. 1, the outlets 52 from the pump 12 are fluidically coupled to the flexible tubing/conduit of the return lines 24 that carries the fluid leaving the outlets 52 either to the vessel 10 or to various processing units 100 that are, in FIGS. 2 and 5, located in-line with the return lines 24. The processing units 100 may perform any number of operations within one or more of these “side streams” that are coupled to the outlet(s) 52 of the pump 12. By way of illustration and not limitation, the processing units 100 may perform one or more of: filtration, buffer addition (buffer feed), dilution (including buffer dilution), media addition (media feed), nutrient addition, sparging gases that are needed or added for the process (e.g., O₂, N₂, or other gases), gas removal, ozone gas addition, waste removal, precipitation of molecule(s) or compound(s) of interest, sensor readings (e.g., pressure, pH, conductivity) and adjustments to same (e.g., pH, conductivity), mixing or maintaining material in suspension continuously, product sampling, other elements that would be typical from other bioprocess steps like harvesting or ultrafiltration/diafiltration (UFDF) washing.

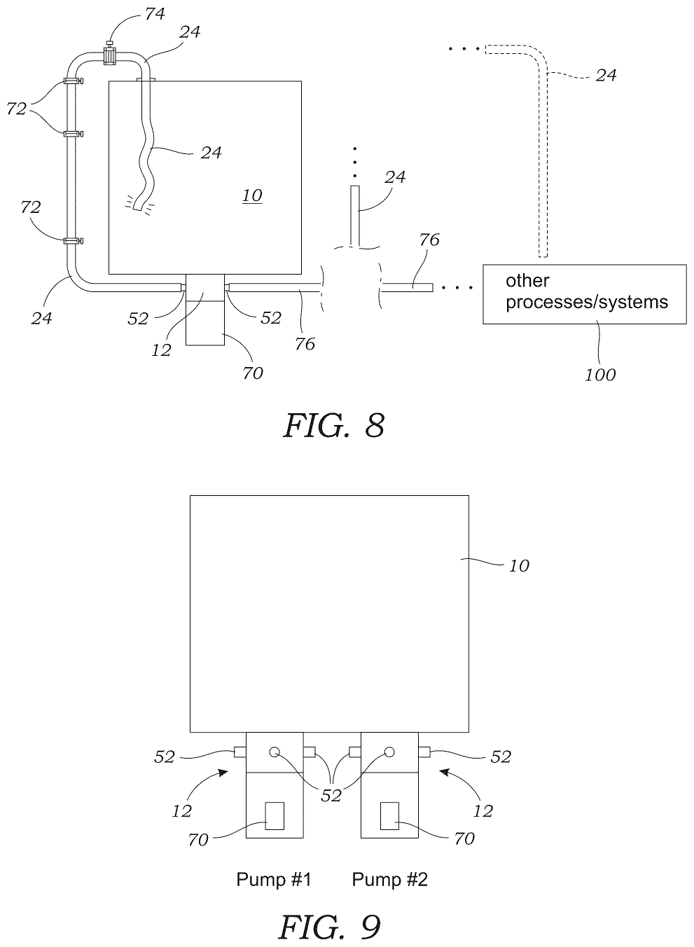

While FIG. 2 illustrates processing units 100 located in each of the illustrated return lines 24 this is not necessarily the case. For example, only some of the return lines 24 may lead to or incorporate processing units 100 (e.g., FIG. 5). Other return lines 24 may return to the vessel 10 without undergoing processing in any processing (via processing unit 100) (see FIG. 8). In some embodiments, the processing unit 100 may be located close to the vessel 10. However, in other embodiments, the processing unit 100 may be located some distance from the vessel 10. In one embodiment and as explained herein, the flexible return lines 24 that are formed form flexible tubing or conduit are encapsulated or jacketed by the two-piece jackets 26. Multiple two-piece jackets 26 may be connected by clamps 72 as illustrated in FIG. 2. In this embodiment, the entirely length of the return lines 24 that are exposed (exterior to the vessel 10) and not otherwise connected to any other components (e.g., valves, sensors, processing units, etc.) are encapsulated by two-piece jackets 26. The flexible return lines 24 may include segments of tubing or conduit that are joined at connection points between adjacent two-piece jackets 26 or other components. In some embodiments, long lengths of flexible tubing or conduit may traverse multiple jackets 26 or other in-line devices (e.g., valves, sensors, processing units 100). Various lengths of tubing/conduit for the return lines 24 are used depending on the particular system setup. As seen in FIG. 2, optional valves 74 are located in the return lines 24. These valves 74 may be used to adjust or control back-pressure within the system.

The use of the two-piece jackets 26 is optional as described herein. In other configurations, the flexible conduit or tubing that forms the return lines 24 have no encapsulating structures. This may be the case, for example, when operating pressures are low and the risk of the flexible conduit or tubing bursting or otherwise failing is low. The return lines 24 may return directly to the vessel 10 or the return lines may have one or more processing units 100 disposed inline as disclosed in the embodiments of FIGS. 2 and 5. Various sensors may also be incorporated into or on the return lines 24.

FIG. 5 illustrates an embodiment of a vessel 10 in the form of a rigid container with an integrated pump 12. Similar components to those of FIGS. 1 and 2 are illustrated with similar reference numbers. In FIG. 5, two processing units 100 (e.g., filtration units) are illustrated connected to return lines 24. In this particular example, the return lines 24 that are located outside the vessel 10 are not flexible: they are formed form a hard or rigid conduit material (or are formed from flexible conduit or tubing encapsulated by jackets 26). The portion of the return line 24 that extends into the vessel 10, however, is flexible and operates as described above. Valves are 74 are located at various locations for draining of fluid, adjusting of system pressure, and the like. It should be appreciated that FIG. 5 just schematically illustrates the setup in the context of a rigid vessel 10 and the invention is not limited to the specific configuration found in FIG. 5.

FIG. 9 illustrates another embodiment of a vessel 10 that has a plurality of pumps 12 integrated in or otherwise coupled to the vessel 10. In the illustrated embodiment, there are two separate pumps 12 that are integrated in the vessel 10. In this embodiment, the vessel 10 would have two apertures 19 with each aperture 19 associated with its own pump 12. Each pump 12 contains multiple outlets 52. In this embodiment, flow from the outlets 52 may be directed to different operations or functional units within the overall system.

The addition of multiple, pump outlets 52 from a common vessel 10 provides added functionality that does not exist currently. While it is known that a single vessel can have multiple gravity discharging outlets, these outlets can be subjected to ballooning due to over pressurization, collapse due to vacuum, kinking due to poor organization of the conduits or even people stepping on them. By employing multiple pump outlets 52, this solves some of these issues. Moreover, combining the multiple outlet design with the encapsulating jackets 26 for the flexible tubing and processing units 100 with multiple streams to manage more efficiently the biological or chemical makeup of the volume in the vessel 10 solves even more problems with current setups. The use of a single or common vessel 10 with multiple, pumped outlets 52 can be a basic building block that makes any pump 12 in a bioprocess/pharmaceutical system work better and enables next generation processing to move forward.

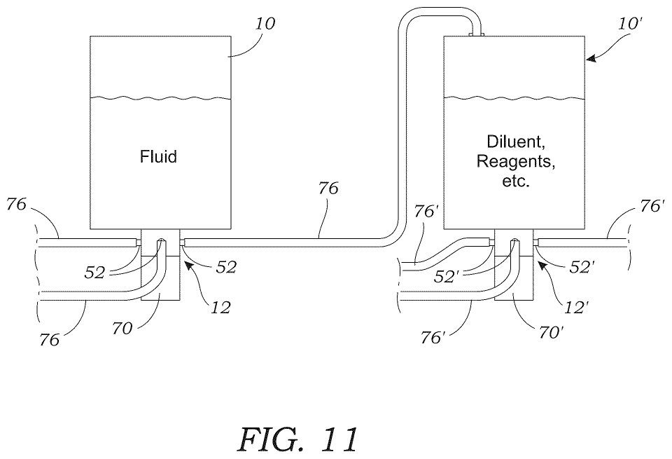

While some of the pump embodiments described herein utilize conduit or tubing as return lines 24 that return to the vessel 10 it should be appreciated that in some embodiments there may be no return lines. For example, the conduit or tubing that are coupled to the pump outlets 52 of pump 12 may lead to separate processing units 100 as described herein. For example, FIG. 11 illustrates an embodiment in which conduit or tubing 76 from a pump 12 having a plurality of outlets 52 leads to a secondary vessel 10′ that also has an integrated pump 12′ with a plurality of outlets 52′. The second pump 12′ has its own motor 70′ and conduit or tubing 76′ is connected to the plurality of outlets 52′. This configuration may be used, for example, in a dilution application where concentrated fluid contained in the upstream vessel 10 is delivered to a secondary downstream vessel 10′ where the fluid is diluted (e.g., in the second vessel 10′). Of course, it should be understood that such a configuration is not limited to dilution applications as various reagents/fluids/agents, etc, may be added in such downstream process units.

While embodiments of the present invention have been shown and described, various modifications may be made without departing from the scope of the present invention. Moreover, it should be appreciated that aspects of one embodiment may be utilized in other embodiments described herein. Thus, feature(s) of one embodiment may be substituted or used in other embodiments. This includes, by way example, the powder barrier, ports, pumps, pump connection types, jackets (or lack thereof), motors, and the like. In addition, while the embodiments described herein have largely been described being used in the context of a bioprocess or pharmaceutical operation, the embodiments are not limited to those applications. For example, the concepts and embodiments described herein may be applied to high-purity chemical systems or in other industries. The invention, therefore, should not be limited except to the following claims and their equivalents.

1. A vessel having an integrated or connected pump comprising:
a vessel comprising a flexible bag or a substantially rigid container defining an interior volume and having a bottom surface, the bottom surface containing an aperture therein for the passage of fluid;
a pump secured to the bottom surface of the vessel, the pump having an inlet in fluid communication with the interior volume via the aperture and a plurality of outlets, wherein the pump pumps fluid from the interior volume of the vessel into the inlet of the pump and out the plurality of outlets; and
one or more conduits or tubing comprising return lines that are connected at one end to the plurality of outlets and having flexible free ends extending into the interior volume of the vessel.

2. The vessel having an integrated or connected pump of claim 1, wherein the one or more conduits or tubing return lines comprise flexible tubing or a flexible conduit.

3. The vessel having an integrated or connected pump of claim 1, wherein the one or more conduits or tubing return lines comprise rigid conduit or tubing located external to the vessel.

4. The vessel having an integrated or connected pump claim 1, wherein the flexible free ends of the return lines terminate at different depths or heights within the interior volume of the vessel.

5. The vessel having an integrated or connected pump of claim 1, wherein the flexible free ends of the return lines comprise end features.

6. The vessel having an integrated or connected pump of claim 1, wherein the number of outlets comprises 2, 3, 4, 5, 6, 7, 8, 9, 10, or more outlets.

7. The vessel having an integrated or connected pump of claim 1, wherein the one or more return lines comprise branched lines.

8. The vessel having an integrated or connected pump of claim 1, wherein the one or more return lines have one or more holes formed in sides thereof.

9. The vessel having an integrated or connected pump of claim 1, wherein the plurality of outlets have different flow rates.

10. The vessel having an integrated or connected pump of claim 1, wherein the plurality of outlets have substantially the same flow rates.

11. The vessel having an integrated or connected pump of claim 1, wherein the return lines enter the vessel at ports contained therein and wherein respective flexible free ends of the return lines are unsecured to the vessel.

12. The vessel having an integrated or connected pump of claim 1, wherein at least one of the return lines is coupled to a processing units that performs one or more of: filtration, buffer addition, buffer dilution, media addition, nutrient addition, sparging of gases, gas removal, ozone gas addition, waste removal, dilution, precipitation of molecule(s) or compound(s) of interest, sensor reading, and pH adjustment, mixing or maintaining material in suspension continuously, product sampling, harvesting or products, or ultrafiltration/diafiltration (UFDF) washing.

13. The vessel having an integrated or connected pump of claim 1, further comprising a port disposed in the aperture of the vessel, wherein the bottom surface of the vessel is secured to the port.

14. The vessel having an integrated or connected pump of claim 13, wherein the port comprises a flanged end and wherein the pump is secured to the flanged end of the port.

15. The vessel having an integrated or connected pump of claim 1, wherein the pump comprises a pump head secured to the bottom surface of the vessel by one of a bonded interface, a welded interface, or an adhesive or glue.

16. The vessel having an integrated or connected pump of claim 1, wherein the pump is integrally molded or formed with the vessel.

17. The vessel having an integrated or connected pump of claim 1, wherein the return lines are contained in a two-piece jacket.

18. The vessel having an integrated or connected pump of claim 1, wherein the vessel comprises a top surface, wherein the return lines pass through the top surface and extend into the interior volume.

19. A method of pumping fluid from a vessel that comprises a flexible bag or a substantially rigid container defining an interior volume and having a bottom surface, the bottom surface containing an aperture therein for the passage of fluid and wherein a pump is secured to the bottom surface of the vessel having an inlet in fluid communication with the interior volume via the aperture and a plurality of outlets coupled to respective conduits or tubing comprising return lines that are connected at one end to the plurality of outlets and having flexible free ends extending into the interior volume of the vessel, the method comprising pumping a fluid contained in the vessel out the plurality of outlets of the pump and back into the vessel.

20. The method of claim 19, wherein the conduits or tubing are coupled to a processing unit that performs one or more of: filtration, buffer addition, buffer dilution, media addition, nutrient addition, sparging of gases, gas removal, ozone gas addition, waste removal, dilution, precipitation of molecule(s) or compound(s) of interest, sensor reading, and pH adjustment, mixing or maintaining material in suspension continuously, product sampling, harvesting or products, or ultrafiltration/diafiltration (UFDF) washing.

21. The method of claim 19, wherein at least one of the conduits or tubing connected the plurality of outlet(s) is coupled to a second vessel that comprises a flexible bag or a substantially rigid container defining an interior volume and having a bottom surface, the bottom surface containing an aperture therein for the passage of fluid and wherein a second pump is secured to the bottom surface of the second vessel having an inlet in fluid communication with the interior volume via the aperture and a plurality of outlets, the method comprising pumping fluid from the interior volume of the vessel using the pump to the second vessel and pumping with the second pump fluid in the second vessel out the plurality of outlets of the second pump.
